(19) United States
(12) Patent Application Publication
(10) Pub. No.: US 2020/0122973 A1
(43) Pub. Date: Apr. 23, 2020

(54) RESISTANCE-BASED INSPECTION OF ELEVATOR SYSTEM SUPPORT MEMBERS

(71) Applicant: Otis Elevator Company, Farmington, CT (US)

(72) Inventors: Peter Keyo, Canton, CT (US); Barry G. Blackaby, Simsbury, CT (US)

(21) Appl. No.: 16/164,146

(22) Filed: Oct. 18, 2018

(51) Int. Cl. B66B 7/12; B66B 1/34; B66B 5/00; B66B 9/00

(52) U.S. Cl. CPC B66B 7/1223; B66B 9/00; B66B 5/0025; B66B 1/3476

(57) ABSTRACT

A method of wear detection of a supporting structure of an elevator system includes measuring an electrical resistance of at least one tension member of a supporting structure via a monitoring system, the supporting structure operably connected to an elevator car and one or more sheaves of an elevator system. A threshold resistance is determined utilizing one or more indicators of an actual traffic pattern of the elevator car. The measured electrical resistance is compared to the threshold resistance, the result of the comparison indicative of wear of the at least one tension member.

### BACKGROUND

Exemplary embodiments generally relates to monitoring systems and methods, and more particularly, to systems and methods for monitoring the condition of a support structure, for example a belt or rope used in an elevator system.

Tensile support structures, such as coated steel belts or wire ropes containing metal cords, are used to move an elevator car up and down within an elevator shaft or hoistway. Because the condition of the tensile support structure is critical to the safety of the operation of the elevator, there is a need to determine the remaining strength level of the tensile support and detect if the remaining strength level falls below a minimum threshold.

The strength of a tensile support structure can be reduced by normal operation of the elevator over time. The primary source of the degradation in the strength of the support structure is the cyclic bending of the support structure around sheaves as the elevator is moved up and down in an elevator shaft or hoistway. The degradation of a support structure is normally not uniform along the length of the support structure, but rather, focused to areas of the support structure that are subjected to high levels or severities of bending cycles.

Some electrical characteristics, such as electrical resistance or impedance, of the cables, cords or tension members in the support structure will vary as the cross-sectional areas of the tension members decrease. Accordingly, it is possible to determine the remaining support strength of the support structure based on the electrical characteristics of the tension members thereof. There currently are some monitoring systems which employ a resistance-based inspection scheme to monitor the resistance of support structures, and thus, the remaining strength thereof. In such systems, a measured electrical resistance is compared to a predetermined resistance threshold such that if the resistance threshold is exceeded, the belt is evaluated for potential repair or replacement. The resistance threshold is determined taking selected factors into account, including an expected elevator system traffic pattern,

### BRIEF DESCRIPTION

In one embodiment, a method of wear detection of a supporting structure of an elevator system includes measuring an electrical resistance of at least one tension member of a supporting structure via a monitoring system, the supporting structure operably connected to an elevator car and one or more sheaves of an elevator system. A threshold resistance is determined utilizing one or more indicators of an actual traffic pattern of the elevator car. The measured electrical resistance is compared to the threshold resistance, the result of the comparison indicative of wear of the at least one tension member.

Additionally or alternatively, in this or other embodiments the one or more indicators includes a count of elevator car starts from a selected landing floor of the elevator system.

Additionally or alternatively, in this or other embodiments the monitoring system is operably connected to a main controller of the elevator system, the main controller providing the count to the monitoring system.

Additionally or alternatively, in this or other embodiments the one or more indicators includes load weight data of the elevator car.

Additionally or alternatively, in this or other embodiments the monitoring system is operably connected to a load weight sensor of the elevator car to provide the load weight data to the monitoring system.

Additionally or alternatively, in this or other embodiments the threshold resistance is re-determined at one or more selected intervals.

Additionally or alternatively, in this or other embodiments the selected interval changes over a service life of the support structure.

Additionally or alternatively, in this or other embodiments the electrical resistance is remeasured at one or more selected measurement intervals.

Additionally or alternatively, in this or other embodiments the method includes one or more of remeasuring the electrical resistance, repairing the support structure or retiring the support structure if the measured electrical resistance exceeds the resistance threshold.

In another embodiment, a monitoring system for a support structure of an elevator car of an elevator system includes a monitoring unit engagable to one or more tension members of the support structure and configured to measure an electrical resistance thereof and compare the measured electrical resistance to a threshold resistance. The monitoring unit is operably connected to one or more elevator system components and is configured to determine the threshold resistance utilizing one or more indicators of an actual traffic pattern of the elevator car.

Additionally or alternatively, in this or other embodiments the one or more indicators includes a count of elevator car starts from a selected landing floor of the elevator system.

Additionally or alternatively, in this or other embodiments the monitoring system is operably connected to a main controller of the elevator system, the main controller providing the count to the monitoring system.

Additionally or alternatively, in this or other embodiments the one or more indicators includes load weight data of the elevator car.

Additionally or alternatively, in this or other embodiments the monitoring system is operably connected to a load weight sensor of the elevator car to provide the load weight data to the monitoring system.

Additionally or alternatively, in this or other embodiments the monitoring unit is configured to redetermine the threshold resistance at one or more selected intervals.

Additionally or alternatively, in this or other embodiments the selected interval changes over a service life of the support structure.

Additionally or alternatively, in this or other embodiments the measurement unit is configured to remeasure the electrical resistance at one or more selected measurement intervals.

In yet another embodiment, an elevator system includes an elevator car, a support structure operably connected to the elevator car and configured to move the elevator car along a hoistway of the elevator system, and a monitoring system including a monitoring unit engagable to one or more tension members of the support structure and configured to measure an electrical resistance thereof and compare the measured electrical resistance to a threshold resistance. The monitoring unit is operably connected to one or more elevator system components and is configured to determine the threshold utilizing one or more indicators of an actual traffic pattern of the elevator car.

Additionally or alternatively, in this or other embodiments the one or more indicators includes one or more of a count of elevator car starts from a selected landing floor of the elevator system, or load weight data of the elevator car.

Additionally or alternatively, in this or other embodiments the support structure is one of a rope or a belt.

### BRIEF DESCRIPTION OF THE DRAWINGS

The following descriptions should not be considered limiting in any way. With reference to the accompanying drawings, like elements are numbered alike:

FIG. 1 is a schematic view of an embodiment of an elevator system;

FIG. 2A is an end view of an embodiment of a support structure for an elevator system;

FIG. 2B is a plan view of an embodiment of a support structure for an elevator system;

FIG. 3 is a schematic illustration of an embodiment of a monitoring system operably connected to a support structure;

FIG. 4 is an illustration of a method of monitoring a support structure; and

FIG. 5 is an illustration of another method of monitoring a support structure.

### DETAILED DESCRIPTION

A detailed description of one or more embodiments of the disclosed apparatus and method are presented herein by way of exemplification and not limitation with reference to the Figures.

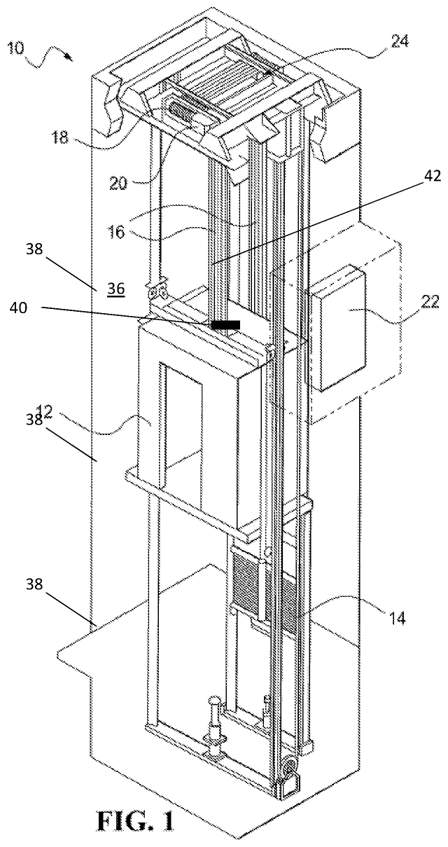

The present invention relates to monitoring of support structures. While FIG. 1 describes one possible support structure, in particular a tensile support structure, namely belts or ropes used to suspend and/or drive components of an elevator system, the present invention could be used with other support structures. Other exemplary support structures include belts or jacketed cords as used in exercise machines, jacketed cables as used with cranes, or any other multistrand wire or rope being used in tension. Referring now to FIG. 1, an elevator system 10 is shown in schematic fashion. It is to be understood that the version of the elevator system 10 shown in FIG. 1 is for illustrative purposes only and to present background for the various components of a general elevator system.

As shown in FIG. 1, the elevator system 10 may include a car 12 coupled to a counterweight 14 by a support structure 16. The support structure 16 may extend over a traction sheave 18 that is driven by a machine 20. Traction between the sheave 18 and the support structure 16 may drive the car 12 and counterweight 14 through the hoistway. Operation of the machine 20 may be controlled by a main controller 22. The elevator system 10 may further include a monitoring system 24 in electrical communication with, and/or disposed in a location proximate to, the support structure 16 and configured to detect the condition of the support structure 16 by measuring, for example continuously or intermittently, the resistance thereof.

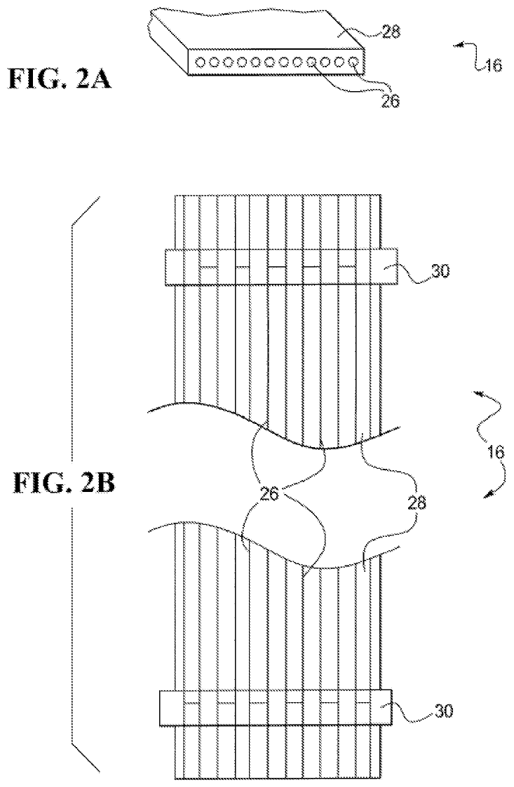

Turning to FIG. 2A, one exemplary support structure 16 is provided in the form of a belt having a plurality of individual tension members 26 in a jacket coating 28. The tension members 26 may include conventional steel wires formed into strands and/or cords, or any other supportive material having an electrical resistance. The jacket coating 28 may comprise one or more materials suitable for promoting traction with the traction sheave 18, such as polyurethane or elastomeric materials. The jacket coating 28 may additionally comprise an electrically insulative material suitable for prohibiting electrical communication therein. The operational condition or state of one or more (including each) tension member 26 of the support structure 16 of FIG. 2A may be determined using a resistance-based inspection scheme, wherein, for example, the remaining life of the one or more tension members 26 of the support structure 16 may be determined in terms of the increase in the resistance of the tension members 26 relative to a baseline value (for example measured during initial installation of the support structure 16 in the elevator system 10. The overall operational condition or state of a support structure 16 could be monitored continuously or intermittently for any substantial increase in resistance. The support structure 16 may also be monitored for any wear in the jacket coating 28 by, for example, detecting for any contact or electrical short between exposed tension members 26 and electrically conductive idler or fraction sheaves 18. In one possible arrangement, the individual tension members 26 may be connected in series so as to minimize the number of monitored resistances and provide one effective resistance per support structure 16. The effective resistance of a support structure 16 may be indicative of the actual resistance, or any multiple, fraction or scale thereof, exhibited by the support structure 16. As shown by the ends of an exemplary support structure 16 of FIG. 2B, the tension members 26 may be coupled or shorted together at alternating and respective ends using connectors 30 so as to electrically connect the tension members 26 associated with one support structure 16 in series form. Other arrangements, such as monitoring one or more tension members 26 in parallel or a combination of parallel and serial monitoring of subsets of the tension members 26, are also possible.

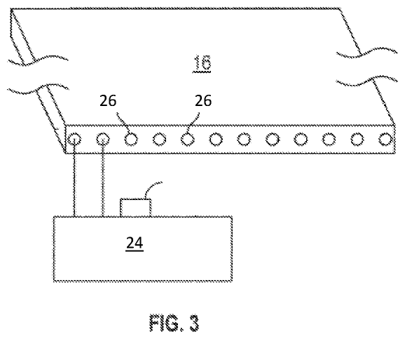

Referring to FIG. 3, the monitoring system 24 is electrically connected to one or more tension members 26 of the support structure 16. Although described below with respect to tension members 26, the monitoring system 24 could be connected to one or more strands or individual wires of the tension members 26. The monitoring system 24 is connected to support structure 16 at a suitable location, for example, at an end of the support structure 16 located at an upper end of the hoistway of the elevator system 10. It is to be appreciated, though, that this location is merely exemplary and other locations for connecting the monitoring system 24 to the support structure 16 are contemplated within the scope of the present disclosure.

During operation, an electrical current is applied through the tension members 26. A resulting voltage allows for determination of an electrical resistance of the tension member 26. This measured resistance is compared to an initial resistance of the tension member 26 measured or established during the initial installation of the support structure 16 to the elevator system 10. A change in the electrical resistance of the tension member 26, typically an increase in resistance, indicates wear of the tension member 26. The change in electrical resistance is compared to one or more thresholds, and when the threshold is exceeded, action may be taken by the elevator system 10, including but not limited to, notifying the maintenance provider, sounding of an alarm, and/or stopping operation of the elevator system 10.

Referring again to FIG. 1, wear of the tension member 26 depends of the traffic pattern of the elevator car 12 along the hoistway 36, for example, cycles of passage of portions of the tension member 26 over the traction sheave 18. As such, when determining the resistance threshold, the monitoring system 24 utilizes an actual traffic pattern of the elevator car 12. Utilization of the actual traffic pattern of the elevator car 12 when determining the resistance threshold allows for a more accurate and less conservative determination of the resistance threshold, thereby potentially extending the useful service life of the support structure 16, compared to a traditional measurement system in which does not take into account an actual traffic pattern of the elevator car. Such a determination results in a more conservative estimation, and thus support structures 16 may be retired from service prior to their useful service life being exhausted.

The actual traffic pattern is determined via intercommunication between the monitoring system 24 and other components of the elevator system 10. For example, the main controller 22 may count quantities of starts at each floor landing 38 of the hoistway 36. Each start at a particular floor landing 38 equates with a passage of a particular portion of the support structure 16 over the traction sheave 18 of the elevator system 10. Further, the monitoring system 24 may be connected to a load weight sensor 40 of the elevator car 12, with the sensed load weights being indicative of tensile loads on the support structure 16, in particular a suspension portion 42 of the support structure 16 between the traction sheave 18 and the elevator car 12.

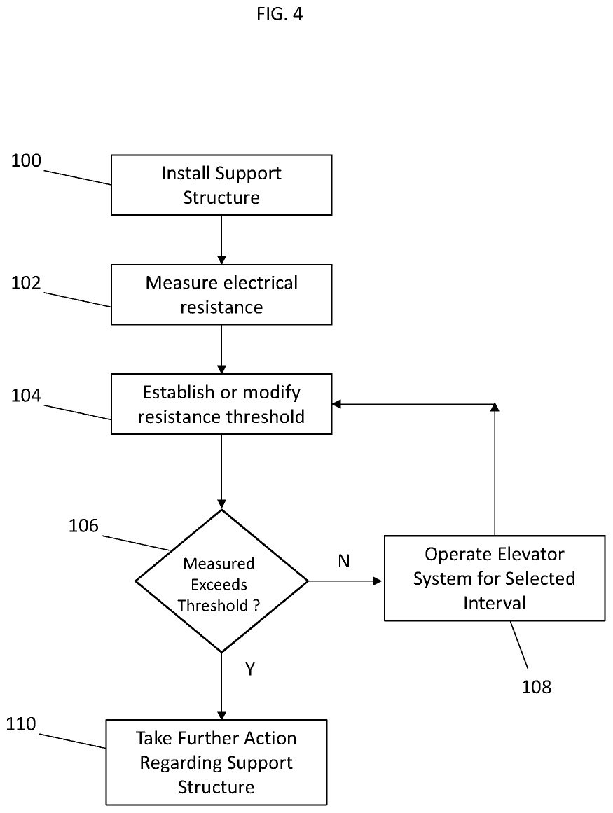

Referring now to FIG. 4, a method of operating an elevator system 10, in particular evaluating a condition of the support structure 16, is illustrated. In block 100, the support structure 16 and monitoring system 24 are installed in the hoistway 36. At block 102, an electrical resistance of at least one tension member 26 of the support structure is measured by the monitoring system 24. At block 104, an electrical resistance threshold is established based on an actual traffic pattern of operation of the elevator system 10. In some embodiments, the actual traffic pattern is determined via communication between the monitoring system 24 and the main controller 22 and/or the load weight sensor 40. At block 106, the measured electrical resistance is compared to the electrical resistance threshold, with the result of the comparison indicative of wear of the at least one tension member 26.

If the measured electrical resistance is below the electrical resistance threshold, at block 108 the elevator system 10 is operated for a selected time interval, for example one month or one year. The stated time intervals are merely exemplary, however, and other time intervals may be utilized. When the time interval is complete, the electrical resistance is remeasured at block 102, and the actual traffic pattern of operation of the elevator system 10 over the time interval may be utilized to modify the electrical resistance threshold at block 104. One skilled in the art will readily appreciate that the electrical resistance of the support structure 16 may be measured at measurement intervals that vary over the service life of the support structure. The measured electrical resistance is compared to the electrical resistance threshold at block 106 and if the measured electrical resistance exceeds the resistance threshold, the support structure 16 is evaluated further at block 110 for further action, which may include, for example, remeasurement of the electrical resistance, or repair or replacement of the support structure 16. If the measured electrical resistance of the support structure 16 does not exceed the resistance threshold, the elevator system 10 is again operated for a selected interval at block 108. It is to be appreciated that the selected interval may remain constant, or alternatively may change relative to previous selected intervals. For example, early in the life of the support structure 16, the selected interval may be relatively long, and may decrease when the support structure 16 nears its projected end of service life.

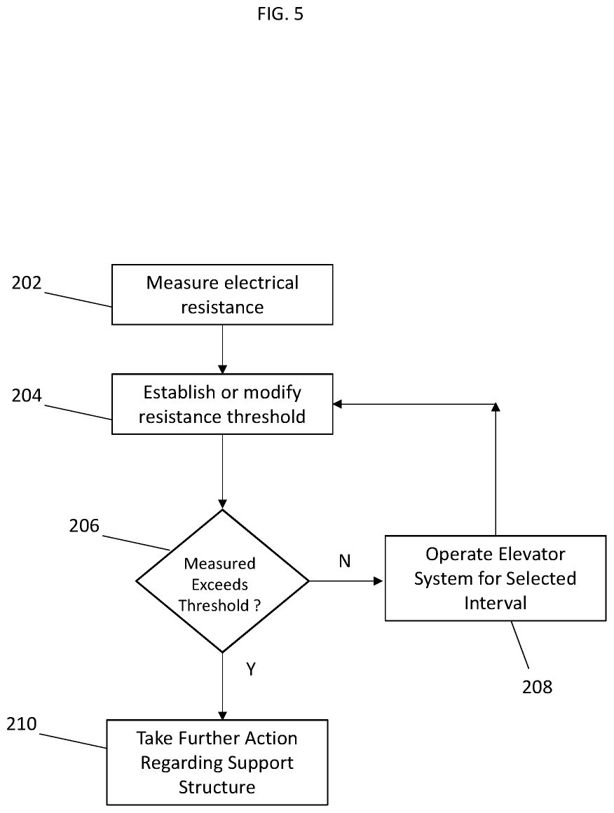

Referring now to FIG. 5, a method of wear detection of the support structure 16 is illustrated. At block 202, an electrical resistance of at least one tension member 26 of the support structure is measured by the monitoring system 24. At block 204, an electrical resistance threshold is established based on an actual traffic pattern of operation of the elevator system 10. In some embodiments, the actual traffic pattern is determined via communication between the monitoring system 24 and the main controller 22 and/or the load weight sensor 40. At block 206, the measured electrical resistance is compared to the electrical resistance threshold, with the result of the comparison indicative of wear of the at least one tension member 26.

If the measured electrical resistance is below the electrical resistance threshold, at block 208 the elevator system 10 is operated for a selected time interval, for example one month or one year. The stated time intervals are merely exemplary, however, and other time intervals may be utilized. When the time interval is complete, the electrical resistance is remeasured at block 202, and the actual traffic pattern of operation of the elevator system 10 over the time interval may be utilized to modify the electrical resistance threshold at block 204. One skilled in the art will readily appreciate that the electrical resistance of the support structure 16 may be measured at measurement intervals that vary over the service life of the support structure. The measured electrical resistance is compared to the electrical resistance threshold at block 206 and if the measured electrical resistance exceeds the resistance threshold, the support structure 16 is evaluated further at block 210 for further action, which may include, for example, remeasurement of the electrical resistance, or repair or replacement of the support structure 16. If the measured electrical resistance of the support structure 16 does not exceed the resistance threshold, the elevator system 10 is again operated for a selected interval at block 208. It is to be appreciated that the selected interval may remain constant, or alternatively may change relative to previous selected intervals. For example, early in the life of the support structure 16, the selected interval may be relatively long, and may decrease when the support structure 16 nears its projected end of service life.

Utilizing actual traffic patterns of operation of the elevator system 10 in determination of the resistance threshold for use in electrical resistance-based evaluation of the support structure 16, reduces uncertainty in establishing the resistance threshold, thus extending useful service life of the support structure 16 and reducing associated costs and maintenance time.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of wear detection of a supporting structure of an elevator system, comprising:
measuring an electrical resistance of at least one tension member of a supporting structure via a monitoring system, the supporting structure operably connected to an elevator car and one or more sheaves of an elevator system;
determining a threshold resistance utilizing one or more indicators of an actual traffic pattern of the elevator car; and
comparing the measured electrical resistance to the threshold resistance, the result of the comparison indicative of wear of the at least one tension member.

2. The method of claim 1, wherein the one or more indicators includes a count of elevator car starts from a selected landing floor of the elevator system.

3. The method of claim 2, wherein the monitoring system is operably connected to a main controller of the elevator system, the main controller providing the count to the monitoring system.

4. The method of claim 1, wherein the one or more indicators includes load weight data of the elevator car.

5. The method of claim 4, wherein the monitoring system is operably connected to a load weight sensor of the elevator car to provide the load weight data to the monitoring system.

6. The method of claim 1, wherein the threshold resistance is re-determined at one or more selected intervals.

7. The method of claim 6, wherein the selected interval changes over a service life of the support structure.

8. The method of claim 1, wherein the electrical resistance is remeasured at one or more selected measurement intervals.

9. The method of claim 1, further comprising one or more of remeasuring the electrical resistance, repairing the support structure or retiring the support structure if the measured electrical resistance exceeds the resistance threshold.

10. A monitoring system for a support structure of an elevator car of an elevator system, comprising a monitoring unit engagable to one or more tension members of the support structure and configured to measure an electrical resistance thereof and compare the measured electrical resistance to a threshold resistance, the monitoring unit operably connected to one or more elevator system components and configured to determine the threshold resistance utilizing one or more indicators of an actual traffic pattern of the elevator car.

11. The monitoring system of claim 10, wherein the one or more indicators includes a count of elevator car starts from a selected landing floor of the elevator system.

12. The monitoring system of claim 11, wherein the monitoring system is operably connected to a main controller of the elevator system, the main controller providing the count to the monitoring system.

13. The monitoring system of claim 10, wherein the one or more indicators includes load weight data of the elevator car.

14. The monitoring system of claim 13, wherein the monitoring system is operably connected to a load weight sensor of the elevator car to provide the load weight data to the monitoring system.

15. The monitoring system of claim 10, wherein the monitoring unit is configured to redetermine the threshold resistance at one or more selected intervals.

16. The monitoring system of claim 15, wherein the selected interval changes over a service life of the support structure.

17. The monitoring system of claim 10, wherein the measurement unit is configured to remeasure the electrical resistance at one or more selected measurement intervals.

18. An elevator system, comprising:
an elevator car;
a support structure operably connected to the elevator car and configured to move the elevator car along a hoistway of the elevator system; and
a monitoring system including a monitoring unit engagable to one or more tension members of the support structure and configured to measure an electrical resistance thereof and compare the measured electrical resistance to a threshold resistance, the monitoring unit operably connected to one or more elevator system components and configured to determine the threshold utilizing one or more indicators of an actual traffic pattern of the elevator car.

19. The elevator system of claim 18, wherein the one or more indicators includes one or more of a count of elevator car starts from a selected landing floor of the elevator system, or load weight data of the elevator car.

20. The elevator system of claim 18, wherein the support structure is one of a rope or a belt.
